(19) United States
(12) Patent Application Publication
(10) Pub. No.: US 2003/0071716 A1
(43) Pub. Date: Apr. 17, 2003

(54) Antenna system architecture with integrated systems

(75) Inventors: Andrew Adrian, Dexter, MI (US); George F. Tannery, Ypsilanti, MI (US); Marian J. Mahoney, Novi, MI (US)

Correspondence Address: Steven L. Oberholtzer, BRINKS HOFER GILSON & LIONE, P.O. Box 10395, Chicago, IL, 60610, US

(73) Assignee: Visteon Global Technologies, Inc.

(21) Appl. No.: 09/976,979

(22) Filed: Oct. 12, 2001

(51) Int. Cl. G05B 19/00

(52) U.S. Cl. 340/5.6; 340/5.72

(57) ABSTRACT

A vehicle includes a shared antenna system. The shared antenna system operates a remote keyless entry system and other systems such as a radio. The antenna is operable to receive at least two signals. The antenna connects with a remote keyless entry system receiver that operates to simultaneously receive the at least two signals. An electronic body control module connects with the remote keyless entry receiver to accommodate operation of a locking system of the vehicle.

### BACKGROUND

The present invention relates generally to vehicular antenna systems, and more particularly to radio antenna system architectures with integrated vehicle features.

Known radio receiver systems often include an individual antenna dedicated to an individual receiver. The one antenna to one receiver relationship is not optimal when multiple receivers are used at a single location. For instance, in vehicular applications, often a user has an AM/FM radio receiver, a cellular phone, a pager, a navigation receiver, a wireless remote entry system and a security system. In some known systems, a separate antenna is used for operating each receiver and separate wiring harnesses to each receiver. Such an arrangement can be cumbersome, difficult to install, costly to vehicle manufacturers and unsightly to vehicle users.

Some known antenna systems that handle multiple functions with one antenna continually cycle from one receive function to another receive function. In other words, the system polls through each receiver band based on a programmed priority system. As the system is polling, the system rematches the physical element set to the polled receiver to optimize the receive function during the polling event.

Thus, there is a need for an antenna-receiver system that overcomes at least some of the above problems.

### SUMMARY

In a vehicle containing a radio, such as an AM/FM radio, a radio antenna is used to route radio and other signals to a receiver. By routing multiple signals through the antenna, multiple systems can be combined to reduce part counts and vehicle costs.

In one embodiment, a shared antenna system operates a remote keyless entry system and other systems, such as a radio. The antenna is operable to receive at least two signals, for example radio signals and a remote keyless entry signal. The antenna connects with a remote keyless entry system receiver that operates to simultaneously receive the at least two signals. An electronic body control module connects with the remote keyless entry receiver to accommodate operation of a locking system of the vehicle.

### BRIEF DESCRIPTION OF THE DRAWINGS

FIG. 1 shows an exemplary vehicle with the antenna system of the preferred embodiments.

FIG. 2 is a block diagram of an embodiment of the antenna system using a concealed antenna.

FIG. 3 is a block diagram of an embodiment of the antenna system in which a remote keyless entry (RKE) receiver is incorporated with an RKE module.

FIG. 4 is a block diagram of an embodiment of the antenna system that combines the RKE receiver with the radio.

FIG. 5 is a block diagram of an embodiment of the antenna system that utilizes a splitter to separate an incoming signal from an antenna.

### DETAILED DESCRIPTION

In a vehicle containing a radio, such as an AM/FM radio, a single antenna is used to route radio and other signals to a receiver. By routing multiple signals through the antenna, multiple systems can be combined to reduce part counts and vehicle costs. Various embodiments are described that use the single antenna system.

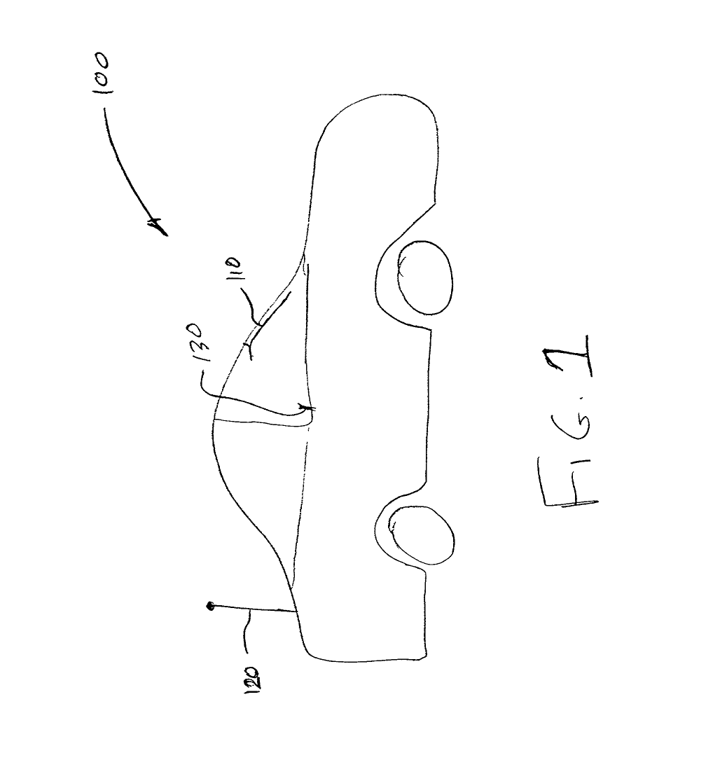

FIG. 1 shows an exemplary vehicle 100 with the antenna system described below. The vehicle 100, which is any device that transports people and/or things, preferably includes an AM/FM antenna for use with an AM/FM radio. The AM/FM antenna can be either a concealed antenna 110, for example concealed within the windshield of the vehicle 100, or of the wand type antenna 120 located on the vehicle. The antenna 110, 120 can preferably receive a remote keyless entry (RKE) signal in addition to receiving radio signals. The vehicle also includes a locking system 130 to protect the vehicle 100 from unauthorized entry into the vehicle 100.

On vehicles using the antenna 110,120 provisions, such as but not limited to diplexing and filtering, are made to rout the RKE signals through the antenna module 210. These provisions are integrated within the antenna module 210. Otherwise, the RKE signal could be rejected and caught in the antenna module 210.

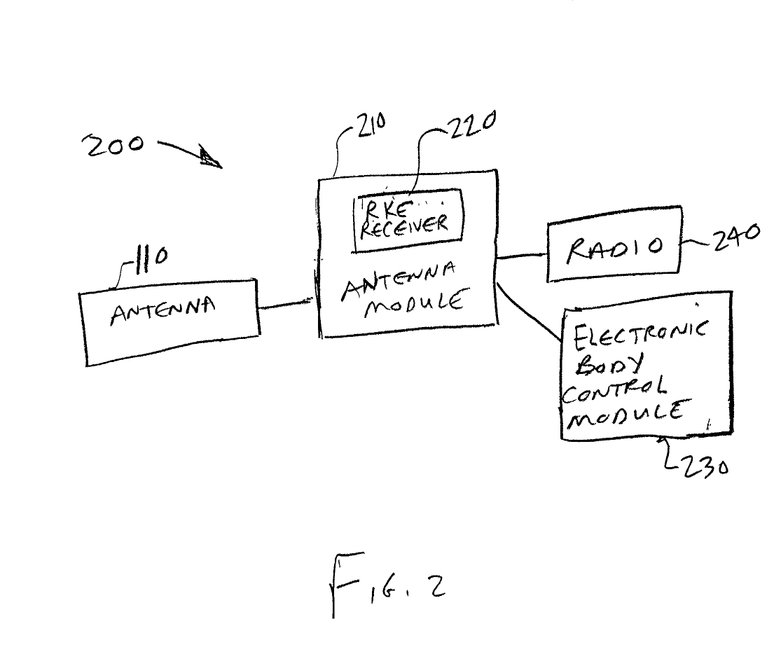

FIG. 2 is a block diagram of an embodiment of a concealed antenna system 200. The concealed antenna 110 connects with an antenna module 210. An RKE 220 receiver is integrated with the antenna module 210. An output of the antenna module 210 is routed to an electronic body control module 230. The electronic body control 230 includes a processor, relay, transistor, switch and/or analog component. The electronic body control 230 controls the vehicle's locking system 130 to lock and unlock the vehicle 100.

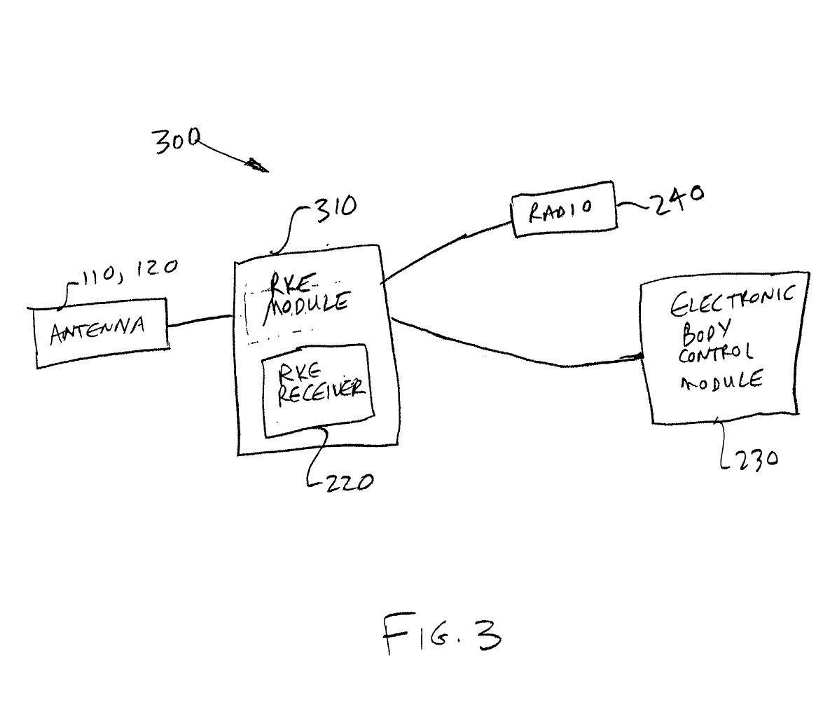

FIG. 3 is a block diagram of an embodiment of a system 300 in which the RKE receiver 220 is separate from the antenna module 210 (FIG. 2) and is incorporated with an RKE module 310. The antenna may include the concealed antenna 110 or the wand antenna 120. Coaxial cabling connects the antenna 110, 120 to an RKE module 310. The RKE module 310 includes the RKE receiver 220 that couples out an RKE signal. The electronic body control module 230 connects to the RKE module 310 to receive the RKE signal to lock and unlock the vehicle 100. The RKE module 310 also may pass radio signals, such as AM/FM signal, to the radio 240.

Thus, the system 300 uses one antenna where two antennas may have been used previously, to reduce parts such as cabling. Also, performance degrading electromagnetic interactions between multiple antennas is reduced.

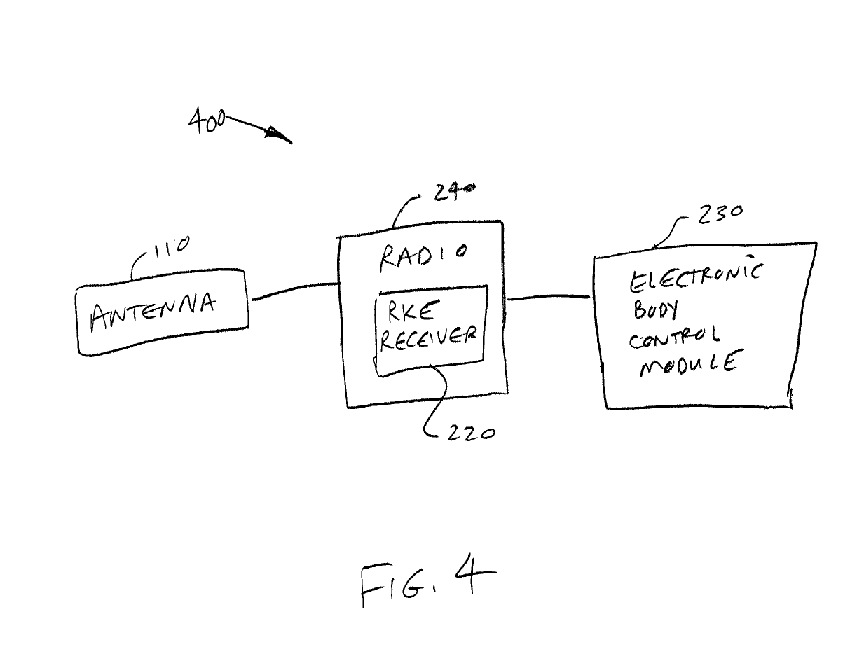

FIG. 4 is a block diagram of an embodiment of a system 400 that combines the RKE receiver 220 with the radio 240. As discussed above, the radio can include and AM/FM radio. The radio 240 connects with the antenna 110. The electronic body control module 230 connects with the radio 240. A protocol for the radio 240 is established for the radio 240 to communicate to the electronic body control module 230. Thus, the antenna 110 can receive RKE signals that are passed on to the electronic body control module 230 via the radio 240, to control the engagement and disengagement of the locking system 130.

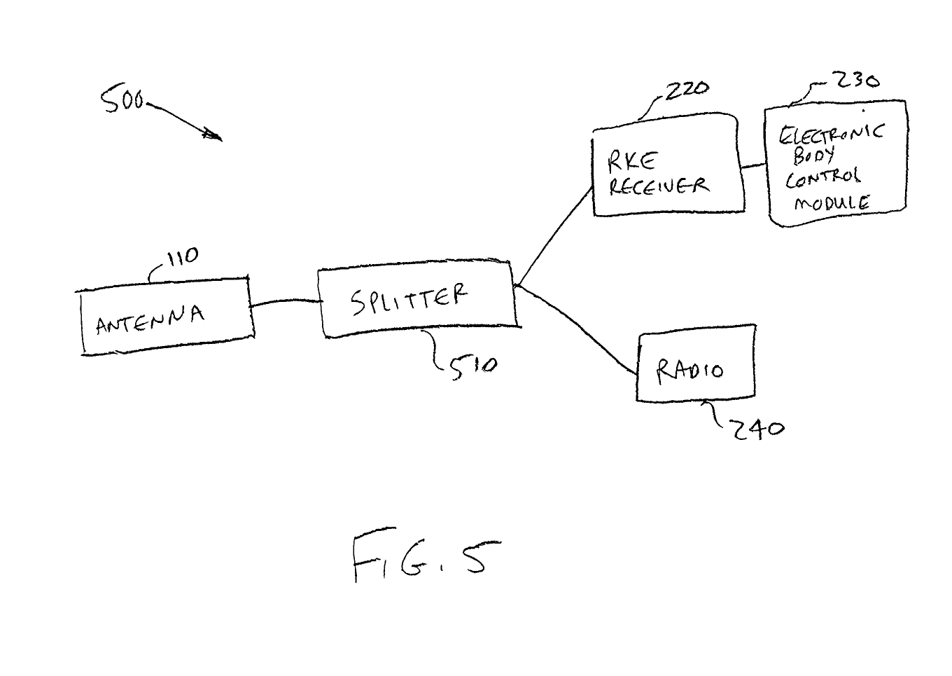

FIG. 5 is a block diagram of an embodiment of a system 500 that utilizes a splitter 510, such as a diplexer, connected with the antenna 110 to separate different types of incoming signals from an antenna 110, such as an RKE signal and an AM/FM signal. Those skilled in the art will appreciate that other signals could be used, such as CB signal, telephone signals and global positioning satellite (GPS) signals. The splitter 510 connects with the RKE receiver 220 and the radio 240 to send an RKE signal to the RKE receiver 220 and a radio signal to the radio 240. The splitter or diplexer can be implemented by connecting the inputs of high-pass, low-pass, or band-pass filters in parallel with multiple outputs. Those skilled in the art will recognize that the topology can be one to two or one to more than two outputs. The RKE receiver 220 connects with the electronic body control module 230. Upon receipt of a signal from the RKE receiver 220, the electronic body control module 230 allows remote entry to the vehicle 100.

The foregoing detailed description has been provided by way of explanation and illustration, and is not intended to limit the scope of the appended claims. Many variations in the presently preferred embodiments illustrated herein will be obvious to one of ordinary skill in the art, and remain within the scope of the appended claims and their equivalents.

We claim

1. An antenna system for operating at least two systems, the antenna system comprising:
an antenna operable to receive at least two signals; and
a receiver connected with the antenna, wherein the receiver is operable to simultaneously receive the at least two signals and separate the signals for simultaneous operation of the at least two systems.

2. The antenna system of claim 1 wherein at least one of the systems comprises a remote keyless entry system.

3. The antenna system of claim 2 further including a locking system connected to the remote keyless entry system, wherein the remote keyless entry system is operable to engage and disengage the locking system.

4. The antenna system of claim 1 wherein the signals include radio signals and remote keyless entry signals.

5. The antenna system of claim 1 wherein the antenna comprises a concealed antenna.

6. The antenna system of claim 5 further including an antenna module.

7. The antenna system of claim 1 further including a remote keyless entry module, wherein a remote keyless entry receiver is included in the remote keyless entry module.

8. The antenna system of claim 7 further including a radio wherein the radio connects with the remote keyless entry module.

9. The antenna system of claim 1 further including a radio wherein a remote keyless entry receiver is included in the radio.

10. The antenna system of claim 9 further including an electronic body control module connected with the radio to operate engagement and disengagement of a locking system.

11. An system for operating a remote keyless entry system, the system comprising:
an antenna operable to receive at least two signals; and
a remote keyless entry system receiver connected with the antenna, wherein the remote keyless entry system receiver is operable to simultaneously receive the at least two signals, one of the at least two signal being for a non-RKE device.

12. The system of claim 11 further including an electronic body control module connected with the remote keyless entry receiver.

13. The system of claim 12 further including a locking system connected to the electronic body control module, wherein the electronic body control module is operable to engage and disengage the locking system.

14. The system of claim 11 wherein the signals include radio signals and remote keyless entry signals.

15. The system of claim 11 wherein the antenna comprises a concealed antenna.

16. The system of claim 15 wherein the remote keyless entry receiver is included in an antenna module.

17. The system of claim 11 further including a remote keyless entry module, wherein the remote keyless entry receiver is included in the remote keyless entry module.

18. The system of claim 17 further including a radio wherein the radio connects with the remote keyless entry module.

19. The system of claim 11 further including a radio wherein the remote keyless entry receiver is included in the radio.

20. The system of claim 19 further including an electronic body control module connected with the radio.

21. An system for operating a remote keyless entry system, the system comprising:
an antenna operable to receive at least two signals;
a splitter connected with the antenna,
a first receiver connected with the splitter to receive a first type of signal; and
a second receiver connected with the splitter to receive a second type of signal.

22. The system of claim 21 wherein the first receiver comprises a remote keyless entry receiver.

23. The system of claim 22 further including an electronic body control module connected with the remote keyless entry receiver.

24. The system of claim 23 further including a locking system connected to the electronic body control module, wherein the electronic body control module is operable to engage and disengage the locking system.

25. The system of claim 21 wherein the second receiver comprises a radio receiver.

26. The system of claim 21 wherein the first type of signals includes radio signals and the second type of signals includes remote keyless entry signals.

27. The system of claim 21 wherein the antenna comprises a concealed antenna.

28. The system of claim 21 wherein the splitter comprises a diplexer.

29. The system of claim 21 wherein the second signal comprises a CB signal.

30. The system of claim 21 wherein the second signal comprises a telephone signal.

31. The system of claim 21 wherein the second signal comprises a global positioning satellite signal.

32. The system of claim 21 wherein the splitter separates more than two sets of signals and connects with more than two receivers.
